(19) United States
(12) Patent Application Publication
(10) Pub. No.: US 2005/0201694 A1
(43) Pub. Date: Sep. 15, 2005

(54) Optoelectronic coupling device

(76) Inventor: Bogdan Rosinski, Brest (FR)

Correspondence Address: HARRINGTON & SMITH, LLP, 4 RESEARCH DRIVE, SHELTON, CT, 06484-6212, US

(21) Appl. No.: 10/505,288

(22) PCT Filed: Feb. 19, 2003
(86) PCT No.: PCT/EP03/50022

§ 371 Date: Apr. 14, 2005

(30) Foreign Application Priority Data
Feb. 21, 2002 (FR) 0202248

(51) Int. Cl. G02B 6/36

(52) U.S. Cl. 385/92; 385/89

(57) ABSTRACT

In order to resolve a problem related to the manufacture of an intermediary optoelectronic coupling device, the inventive device is provided with a curved mirror having focusing properties. In this way, an additional degree of freedom can be availed of in order to adapt the device to different optical transmission modes: single-mode or multimodes.

### BACKGROUND OF THE INVENTION

1. Field of the Invention

An object of the present invention is an improved optoelectronic coupling device. It is intended for use in the field of optical fibers. Optical fibers are used to convey light signals at high throughput rates.

An optical fiber is used essentially as a means to convey information in the form of light signals that are normally digitized. This means of transportation has the advantage of efficiently resisting noise, especially electromagnetic noise, and furthermore enabling very high data bit rates. However, since processing in present-day computer devices is of the electronic type, it is important to carry out an optoelectronic conversion of the light signals to be processed at input and output of the optical fiber. Various solutions have been devised for these problems of conversion.

2. Description of the Prior Art

Certain solutions have entailed the idea of making harnesses. In these harnesses, an optical fiber or a bundle of optical fibers is provided, fixedly at both ends (or at least at one of its ends), with an optoelectronic conversion device. In this case, the optical fiber delivers electrical signals or electronic signals at one or both ends while it can deliver optical signals at another end. The drawback of this type of solution is, firstly, the cost generated by this integration of means. Secondly, the ease with which fiber can be handled is thereby greatly reduced. Indeed, it will easily be understood that the length of the fiber cannot be adjusted as easily as desired, especially if it is provided on either side with electronic conversion circuits crimped to the ends of the fibers. In this case, it is not at all possible to lengthen or shorten the fiber. All that can be done is to exchange it for another differently sized harness, which however will also be a high-cost harness. Besides, the presence of the electronic conversion circuit leads to the making of a joining piece at the end of the optical fiber. The bulkiness of this joining piece is inconvenient if the fiber has to be threaded into narrow holes to conduct the signals from one place to another.

In other approaches, especially the document WO 00/55665, an intermediate ferrule has been devised. This ferrule is designed firstly to enable optical connection and is provided furthermore with integrated optoelectronic conversion means. However, owing to the chosen technique of transmission and the mechanical architecture used to make the device, an optical reflection mirror has to be prepared between the exit of the optical fibers and an optoelectronic detector or emitter responsible for making the conversion. Mirror-based approaches of this kind can also be found in the following documents: U.S. Pat. No. 5,168,537, U.S. Pat. No. 6,132,107, and U.S. Pat. No. 6,161,965.The presence of such mirrors however raises optical and technological problems that impair the efficiency of the optoelectronic conversion undertaken and are a source of optical transmission losses.

Mirror-based solutions indeed raise problems that are hard to resolve. In particular, for reasons of manufacturing quality, a package designed to receive the optical port is generally made in a crystalline silicon substrate. Consequently, if the reflection mirror is to be perfectly reflective, it must be chosen as being one of the main planes of the crystalline structure of the substrate. Such an approach is presented, for example, in the document U.S. Pat. No. 6,161,965. Thus, the choice of such a solution with such a substrate leads to an angle of reflection of 54 degrees and not 45 degrees. Furthermore, the signals coming from the optical fiber or from an optical emitter integrated circuit are normally divergent, unless costly modifications are made to the emitter parts. To then obtain sufficient reflection, a refocusing or collimating operation is carried out on the light signals transiting between an output of the optical fiber and a light-emitting or light-detecting integrated circuit. This is described particularly in the document U.S. Pat. No. 5,168,537. The document provides for making a prism, forming the expected reflecting surface by its inclined surface and provided on its input and output faces with two refocusing or collimating lenses. A device of this kind is naturally far too complicated and far too costly to be made on an industrial scale at low cost.

Finally, another problem arises. It is linked to the fact that the optical fiber used with the ferrule is either a single-mode or a multimode type of fiber. Indeed, if the type of light injection is of the single-mode type, several modes of propagation are simultaneously present in the fiber. Now these different modes have propagation speeds or phase rotations such that, depending on the distance between the place at which they are taken and the place at which they are injected, destructive interferences may arise. The result of this is that a digital type of signal, of the all-or-nothing type, with sudden transitions will be transmitted in the form of the signal with a rise time that is far greater than the rise time of the optical excitation signal. Indeed, certain spectral components undergo these interferences. Consequently, the transmission bandwidth of the optical fiber, in terms of gigabits per second, may be reduced owing to the optoelectronic conversion deficits.

In the invention, to resolve these problems, it is planned to make a reflective mirror which itself has a faculty of focusing at a point not at infinity. In practice, the reflecting mirror of the invention has a curvature that is preferably of the parabolic type. Consequently, this mirror itself has properties of refocusing a divergently received light beam. With such a mirror, it is furthermore possible to place the end of the optical fiber at a distance that may be adjusted relative to this mirror. Then, in a development prototype, the ferrule of the invention has the following elements facing the mirror: firstly the optoelectronic circuits for the detection or emission of light rays and secondly a first end of an optical fiber that is respectively an emitter or receiver of these light rays. With this prototype, it is possible, in moving away from or approaching this first useful end of the optical fiber, to measure a result of transmission of these light signals at the other end of this optical fiber. It is very easy to find an optimum remoteness between the first useful end of the optical fiber and the curved mirror. The optimum corresponds either to a maximum of light power transmitted for a range of wavelength or, especially in the case of wideband multimode fibers, to an optimum bandwidth.

It is observed that, in this case, a divergence of emission or injection of about 20 degrees can be accepted on a termination of an optical fiber and that such a tolerance allows the receiving of a greater number of optical terminations without necessitating any particular truing or polishing operations for these terminations. Furthermore, since it is an expected mode of injection, with the trials indicated here above, it is possible to determine the optimum distance of remoteness of the terminations of the optical fiber from the curved mirror and to make stops in an optical port receiving a detachable optical fiber joining piece in order to fix the distance between the terminations of these fibers and this mirror at a distance equal to the optimum distance. If need be, intermediate sections of optical fibers are used, these sections being perfectly secured. Ultimately, in acting thus, an additional degree of optimization is obtained at lower cost, the mirror comprising the lenses in itself because of its curvature.

### SUMMARY OF THE INVENTION

An object of the invention therefore is an optoelectronic coupling device comprising a package provided with an optical port to receive terminations of optical fibers, a mirror in a cavity to reflect light rays coming from or intended for these optical fibers, an optoelectronic circuit to convert these light rays into electrical signals or vice versa, characterized by the fact the package is made of plastic and that the mirror is capable of focusing at a finite distance and that the optoelectronic circuit is mounted on the package by reflow soldering of solder beads and comprises an intermediate integrated circuit surmounted by means of reflow soldering with solder beads, detection or transmission circuits being spaced out at the pitch of the grooves of the package.

### BRIEF DESCRIPTION OF THE DRAWINGS

The invention will be understood more clearly from the following description and the accompanying figures. These figures are given purely by way of an indication and in no way restrict the scope of the invention. Of these figures:

FIGS. 1a and 1b are respectively longitudinal section and cross-section views, relative to the optical path, of an optical coupling device of the invention, also called a ferrule by extension;

FIGS. 2a and 2b are sectional views longitudinal to the optical path, into perpendicular planes, of the ferrule of the invention and its method of assembly and use.

### MORE DETAILED DESCRIPTION

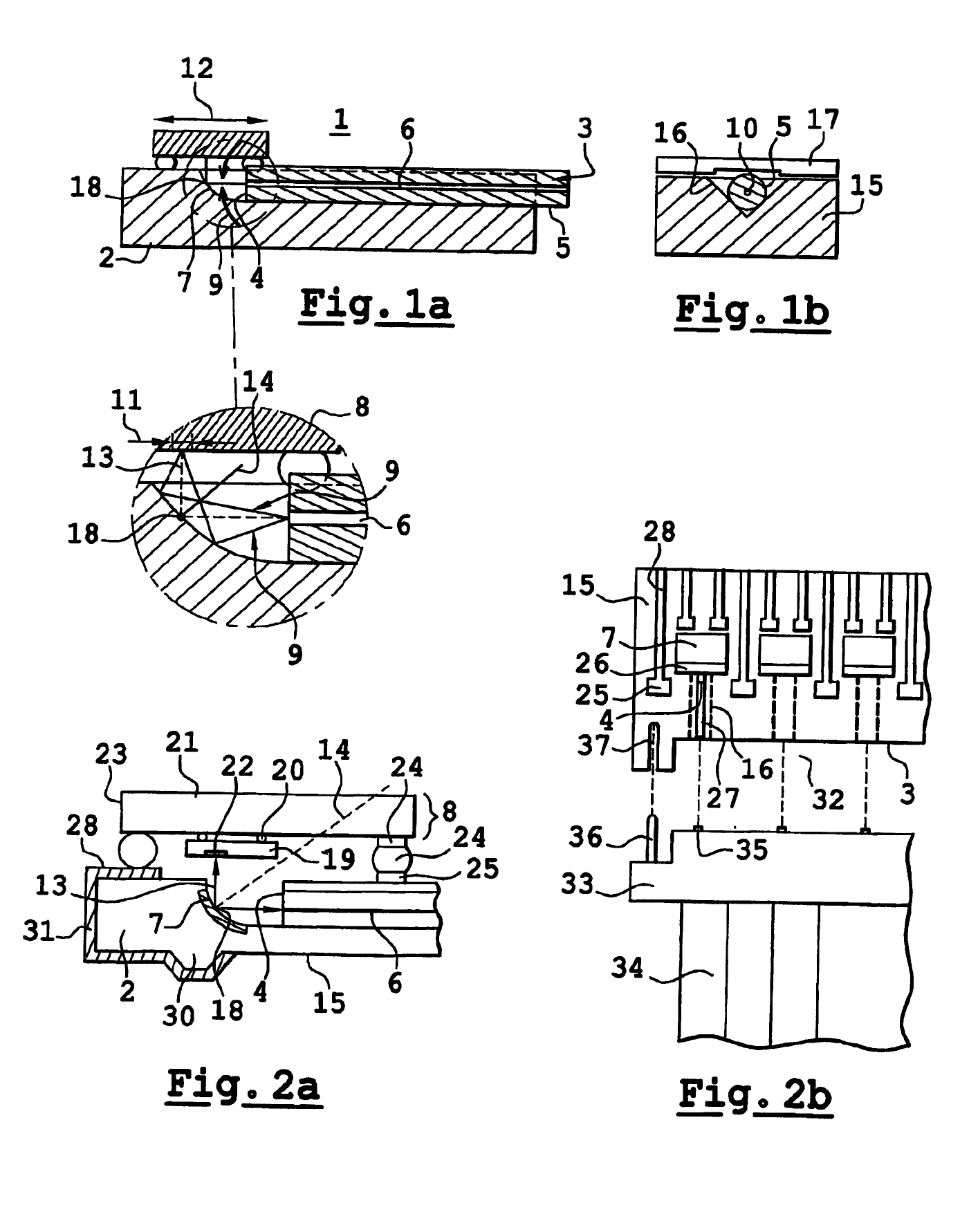

FIG. 1a is a schematic view of an optical coupling device 1 or optoelectronic connection ferrule according to the invention. The ferrule 1 has a package 2 provided with an optical port 3 to receive terminations 4 of optical fibers 5. The optical fibers 5 may be carried by a holding joining piece as shall be seen further below. The terminations 4 may be finished, especially polished, according to the teaching of the documents cited. The ferrule 1 may nevertheless comprise an intermediate optical path 6, provided with intermediate optical fiber sections, the detachable joining piece of the optical fibers being shifted. Thus, the terminations 4 may be located at a distance that is perfectly adjusted and fixed in the ferrule 1. In this case, an optical-optical coupling is provided between these intermediate sections of optical fibers at their other end, and terminations of optical fibers to be connected.

The ferrule 1 also has a mirror 7, designed to reflect light rays coming from the optical fiber 5 toward an optoelectronic circuit 8, or vice versa. The optoelectronic circuit 8, represented schematically herein, may be an optical detector as well as an optical emitter. It is placed above the package 2.

According to a main characteristic of the invention, the mirror 7 is concave-curved, presenting the interior of the cavity formed by this concavity for the reception and reflection of the light signals coming from or intended for the optical fibers 5. In a classic application, the angular aperture 9 of the light beam both on the terminations 4 of the optical fiber 5 and on the optoelectronic circuit 8 is about 20 degrees. In this example again, the diameter of the core 10 of the optical fiber (FIG. 1b) is of the order of 10 micrometers, in the same range as a dimension 11 of a useful surface of detection or emission on the integrated circuit 8. By way of comparison, the overall dimension 12 of the individual circuit 8 is of the order of 300 micrometers.

Although the concavity of the mirror 7 may be spherical, a parabolic shape will be preferred for it, the axis of the parabola being substantially oriented as the bisectrix of the angle formed by a line 13 normal to the integrated circuit 8 and the optical path 6. Such a concave shape may, preferably, in the invention be obtained by molding the package 2. To this end, the package 2 will be made of either insulating ceramic or plastic. For reasons that shall be explained further below, it will then be made out of a plastic material supporting a high rise in temperature, especially of LCP (liquid-crystal polymer), PBT (polybutylene terephtalate, or even COC (cyclic oleofin copolymer) or polyimide. However, other methods of manufacture could be used. In particular, a laser sculpturing of the mirror 7 could be envisaged.

The reflective character of the mirror 7 is obtained by the addition of a crystalline or polycrystalline metal layer. The addition of this layer may be done in different ways. Either the totality of the package is metallised and then etched, or certain parts of the surface of the package are corrosively treated so that a metallization, especially by vaporization of metal atoms, is done, preferably on zones activated during the corrosion (especially on the mirror). In the former case, the etching may be dry, by laser, or by wet processing, using especially photolithography type methods.

The additional characteristic of reflection of the mirror 7 of the invention is therefore that it can be focused at a finite distance, for example at the focal point of the parabola or at the center of the sphere in the case of a spherical mirror. For other shapes it is possible, under the same conditions, to define the existence of a focal point even if the astigmatism of the lens thus formed is not perfect. Preferably, the curvature is adapted to the single-mode or multimode character expected for the transmission of the light signals.

FIG. 1b shows a base 15 of the package 2. The base 15 is provided with V-grooves 16 designed to receive either the optical fibers themselves or intermediate sections of optical fibers 5. The base 15 is designed to be covered with a lid 17 for holding optical fibers, or intermediate sections of optical fibers 5. This embodiment enables the making, in the package 2, of a channel used to place the termination 4 of the optical fibers or sections of optical fibers, at a preferred place, whose value has been measured by a series of experiments. These experiments improve the efficiency of the optoelectronic conversion undertaken. Consequently, before the positioning of the lid 17, it is possible to adjust the position of the termination 4 relative to the center 18 of the mirror 7. The experiments may include the testing of the optoelectronic connection measured after the light signals have been conveyed over a long distance, for example a distance of about one kilometer or more. The center 18 of the mirror is located, for example, at the intersection of the mirror with the bisectrix 14.

FIG. 2a provides a sectional view of a preferred embodiment of the ferrule of the invention. The integrated circuit 8 comprises firstly an optoelectronic emitter or detector integrated circuit 19 mounted by the reflow soldering of solder beads 20 on a driving integrated circuit 21. The driving circuit 21 is especially a circuit capable of reshaping the analog signals delivered by the detector or the emitter 19. The use of reflows of solder beads such as 20 enables the circuit 19, especially its sensitive zone 22 (sized 11) to be positioned with high precision relative to the circuit 21, for example relative to an edge 23 of this circuit 21. This circuit 21 is furthermore mounted on the pack 2 by means of reflow solderings of solder beads 24, also enabling a perfect positioning of the driving circuit 21 relative to the center 18 of the mirror 7. This then leads to the result wherein the mirror 7 is positioned, on the one hand, with precision relative to the terminations 4 (owing to their adjustment in distance and owing to the way in which they are held precisely in their V-grooves 16), and is positioned, on the other hand, with precision relative to the detection integrated circuit 19.

The precise positioning by reflow soldering of solder beads results from the development of surface tensions in the solder beads, between these beads and contact zones such as 24 or 25, at the time of the reflow soldering. The zones 24 or 25 are made precisely by construction respectively on the integrated circuit 8 and on the pack 2. The reflow method (which is performed at temperatures of around 200° C.) furthermore implies the use of a package 2 (base 15-lid 17) obtained from a material that is stable at high temperatures, whence the choice of the preferred plastic materials.

The driving circuit 21 forms an intermediate integrated circuit. It may be large-sized. Several detection or emission circuits such as 19 may be mounted on such a driving circuit 21. In this case, these circuits 19 are spaced out from one another, precisely, by a pitch corresponding to the pitch of the grooves 16 in the base 15 of the pack 2. In this respect, FIG. 2b gives a view in a base 15 of the presence of cavities 26 containing the mirrors 7. Preferably, the mirrors 7 are cylindrical, with circular or parabolic directrix, and a generatrix perpendicular to the normal 13 and the path 6. They could however be generated by revolution, especially around a large axis 14. FIG. 2b shows sections 27 of optical fiber ending in the cavities 26, their ends 4 close to the mirror 7 having been adjusted in depth. The sections 27 are crimped into the grooves 16. The grooves 16 are shown in dashes because they are not located in the plane of the section, these being taken above the lid. The lid 17 is thus crossed by electrical tracks such as 28 which enable the connection of the pins 25 to connection bosses 30 (FIG. 2a). To this end, the package 2 has metal tracks used to circumvent the surface of the base 15, especially in passing through a front edge 31. At the position of the connection of the lid 17 and the base 15, electrical bridges are made. The bosses 30, whose number and distribution are adequate, are designed to be placed in contact with contacts of a printed circuit (not shown) receiving the ferrule 1. The pins 25 are pins placed with precision on the surface of the base 15 or of the lid 17 to receive the solder beads 24. Preferably, the tracks 28 are made by a same operation as that of the metallization of the mirror 7.

FIG. 2b shows that the ferrule 1 is provided with a receptacle 32 to receive a joining piece 33 gripping a bundle 34 of optical fibers. The ends 35 of the optical fibers of the bundle 34 are designed to come into contact with the optical port 3. However, the optical-optical coupling between the intermediate sections 27 and the optical fibers of the bundle 34 may be prevented if the optical outputs 35 are guided up to a position where they are vertical to the expected location of the optical terminations 4. To enable accurate guiding of the joining piece 33 in the receptacle 32, this joining piece 33 furthermore has pins 36 that get inserted into reserved locations 37 made so as to be facing the base 15. The joining piece 33 and the receptacle 32 are preferably standardized.

1. Optoelectronic coupling device comprising a package provided with an optical port to receive terminations of optical fibers, a mirror in a cavity to reflect light rays coming from or intended for these optical fibers and an optoelectronic circuit to convert these light rays into electrical signals or vice versa, characterized by the fact that the package is made of plastic and that the mirror is capable of focusing at a finite distance and that the optoelectronic circuit is mounted on the package by reflow soldering of solder beads and comprises an intermediate integrated circuit surmounted by means of reflow soldering with solder beads, detection or transmission circuits being spaced out at the pitch of the grooves of the package.

2. Device according to the claim 1, comprising sections of intermediate optical fibers.

3. Device according to claim 1, characterized by the fact the mirror is parabolic.

4. Device according to claim 1, characterized by the fact the mirror is metallised.

5. Device according to claim 1, characterized by the fact the package comprises metallised tracks.

6. Device according to claim 1, characterized by the fact the package has V-grooves.

7. Device according to claim 1, characterized by the fact the curvature of the mirror is adapted to the single-mode or multimode character of the light signals.

8. Device according to claim 1, characterized by the fact the mirror is concave curved.

9. Device according to claim 1, characterized by the fact the plastic material of the package is a high-temperature plastic material, made, for example, of liquid-crystal polymer, polybutylene terephtalate, cyclic oleofin copolymer or polyimide.
